(19) United States
(12) Patent Application Publication
(10) Pub. No.: US 2016/0042836 A1
(43) Pub. Date: Feb. 11, 2016

(54) Insulated Wire, Rotary Electric Machine, and Method for Manufacturing Insulated Wire

(71) Applicant: Hitachi, Ltd., Tokyo (JP)

(72) Inventors: Yoshiaki OKABE, Tokyo (JP); Kotaro ARAYA, Tokyo (JP); Takahito MURAKI, Tokyo (JP); Satoru AMOU, Tokyo (JP); Tadashi ARAI, Tokyo (JP)

(21) Appl. No.: 14/813,367

(22) Filed: Jul. 30, 2015

(30) Foreign Application Priority Data
Aug. 8, 2014 (JP) 2014-162016

(51) Int. Cl. H01B 7/29; H01B 13/14; H01B 3/04; H01B 3/40; H01B 3/28

(52) U.S. Cl. CPC H01B 7/292; H01B 3/40; H01B 3/28; H01B 3/04; H01B 13/145; H01B 13/143

(57) ABSTRACT

Provided are an insulated wire which is excellent in heat resistance and pressure resistance, and a rotary electric machine which uses the same. An insulated wire includes an insulating resin layer that is formed on an outer periphery of a conductor, in which the insulating resin layer has a thermoplastic phenoxy resin, an epoxy resin, a cross-linking agent, an inorganic filler, and fine rubber particles.

### TECHNICAL FIELD

The present invention relates to an insulated wire.

### BACKGROUND ART

Currently, further miniaturization or high output of a rotary electric machine such as a motor for drive which is used in a household electric appliance, an industrial electric machinery, a vessel, a railroad, or an electric vehicle, has been promoted.

Densification or improvement of a space factor of a winding wire of the rotary electric machine, is needed in order to achieve the miniaturization or the high output of the rotary electric machine, but it is necessary to prevent dielectric breakdown due to self-heating of the winding wire or partial discharge between the adjacent winding wires at the time of the densification of the winding wire. Moreover, in an inverter control where application of the motor for drive is expanded, it is necessary to prevent the dielectric breakdown in association with a surge voltage which is generated by switching.

Therefore, in an insulating resin that is used in an insulated wire which is made to be the winding wire, more excellent heat resistance and voltage resistance (referred to as pressure resistance, hereinafter) are needed.

In PTL 1, from a viewpoint of reducing the number of steps by impregnation varnishless, an insulating material is applied and baked on a conductor, and a fusion layer is formed thereon, and an enamel wire having self-fusing properties is disclosed.

In PTL 2, a DC power cable in which an extruder is used, and an insulator layer is formed on an outer periphery of a conductor by extrusion coating, is disclosed.

### CITATION LIST

### Patent Literature

[PTL 1] JP-A-2012-87246

[PTL 2] JP-A-2009-114267

### SUMMARY OF INVENTION

### Technical Problem

By coating the outer periphery of the conductor with a resin material which is excellent in the heat resistance, it is possible to secure the heat resistance of the insulated wire. However, generally, in the insulated wire, not only the heat resistance but also various properties such as the pressure resistance, mechanical strength, chemical stability, water resistance and moisture resistance, are needed. In particular, in order to secure the pressure resistance of the winding wire, it is necessary to coat the conductor with a film thickness of a fixed degree or more.

As disclosed in PTL 1, in order to form an insulating resin layer having the sufficient film thickness to the insulated wire by the applying and baking step, it is necessary to repeat the applying and baking step many times, and there is a problem that a manufacturing cost is high.

On the other hand, as disclosed in PTL 2, in order to manufacture the insulated wire by a method using the extruder, a temperature in a case of heating the material before extrusion molding, may be needed to be lower than the temperature in the case of heat curing a coated portion of the insulated wire after the extrusion molding. However, the enamel wire of PTL 1 has a sulfone group-containing polyhydroxy polyether resin which is obtained by copolymerizing a bisphenol A type epoxy unit and a bisphenol S type epoxy unit, and a melting temperature of the enamel wire is 200° C. or more and is too high, and thus, it is not possible to manufacture the insulated wire by the method using the extruder of PTL 2.

An object of the present invention is to provide an insulated wire which is excellent in heat resistance and pressure resistance, and a rotary electric machine which uses the same.

### Solution to Problem

An insulated wire according to the present invention, includes an insulating resin layer that is formed on an outer periphery of a conductor, in which the insulating resin layer has a thermoplastic phenoxy resin, an epoxy resin, a cross-linking agent, an inorganic filler, and fine rubber particles.

### Advantageous Effects of Invention

According to the present invention, it is possible to provide an insulated wire which is excellent in heat resistance and pressure resistance.

### BRIEF DESCRIPTION OF DRAWINGS

FIG. 1 is a schematic cross-sectional view of an insulated wire according to Example 1.

FIG. 2 is a schematic cross-section view of an insulated wire according to Example 2.

FIG. 3 is an enlarged view of a rotary electric machine (stator) including the insulated wire.

FIG. 4 is a diagram describing a method for manufacturing an insulated wire according to the present invention.

### DESCRIPTION OF EMBODIMENTS

Hereinafter, an insulated wire according to an embodiment of the present invention, and a rotary electric machine which uses the same, will be described in detail.

The insulated wire according to the present invention, is a wire including a conductor and an insulating resin layer which is formed by an extrusion process. It is a feature that the insulating resin layer of the wire is a heat curable resin of which an elongation percentage is large at the time of an electrifying step, and which has self-fusing properties by a heat treatment after the electrifying step.

A winding wire according to the embodiment, is suitable for the rotary electric machine, and is a wire which can be used in a high density environment of a state where the wires are close to each other by being wound. Moreover, it is the feature of the embodiment that a crack or floating is not caused in the heat curable resin at the time of the winding wire work, and thereafter, at the time of the heat treatment, the winding wire is cross-linked after the self-fusing.

A resin composition of the present invention is a heat curable resin where after the winding wire is obtained by extrusion molding, the work of the electrifying step is performed, and thermal cross-linking is made. Since the present winding wire to which the extrusion molding is performed is wound, the elongation percentage is necessary for the resin at the time of being wound, in order to prevent the crack or the like from being generated in the resin of the winding wire by the winding wire work of the state before the heat curing. However, the composition that is the heat curable resin which is excellent in heat resistance, and meets moldability or the elongation percentage in performances before the heat curing, was not found.

Therefore, the present inventors search for the resin which is the heat curable resin, and is excellent in the moldability so that the winding wire can be made before the heat curing, and of which the elongation percentage is large. The present inventors newly found out a heat curable resin composition of mixing the heat curable resin of low viscosity which is made up of a phenoxy resin of high molecular weight having an epoxy group at a terminal, an epoxy resin having a similar skeleton to the phenoxy resin, and a curing agent, with a scale-shaped inorganic filler and fine rubber particles, in order to increase the elongation percentage of the resin.

A point to which is paid attention, is a point that the scale-shaped inorganic filler and the fine rubber particles are arrayed between the phenoxy resin and the like of heat curable resin ingredients. The phenoxy resin is a thermoplastic resin having excellent tenacity and flexibility. Therefore, by using a hydrogen bond that occurs between hydroxyl groups which are largely included in the phenoxy resin, and the hydroxyl groups of the inorganic filler, the increase of the elongation percentage of the resin is achieved. In addition, by a low elasticity effect of the fine rubber in the resin, a resin crack which is likely to be caused at the time of pulling the winding wire, for example, winding the wire, is prevented in the fine rubber. By a synergistic effect of the two ingredients, without largely increasing the melting viscosity at the time of the extrusion molding, the elongation percentage of the heat curable resin before the heat curing after the extrusion winding wire, can be large. Therefore, reliability of the wire is largely improved.

From results of various types of tests, in order to prevent the resin crack of the winding wire, the elongation percentage of the heat curable resin is preferably 5% or more, and is particularly preferably 10% or more. However, if the elongation percentage is 100% or more, adhesive properties before the curing, or the heat resistance after the curing in the heat curable resin, is lowered. When both of the prevention of the resin crack of the winding wire, and the lowering of the adhesive properties before the curing or the heat resistance after the curing in the heat curable resin, are balanced, it is preferable that the elongation percentage of the heat curable resin is 30% or more, and less than 80%.

The heat curable resin of the present invention, can have the low melting viscosity, by mixing a cross-linking ingredient of low molecular weight with the phenoxy resin. As a result, since an extrusion moldable temperature can be reduced (to be 100° C. to 150° C.), the inorganic filler and the rubber can be mixed. It is effective for the manufacturing process, and the reduction of a raw material cost. If an extrusion molding temperature is high, since the cross-linking of the heat curable resin partially proceeds, it leads to the reduction of the elongation percentage of the resin. Therefore, it is preferable that the extrusion molding temperature is low as much as possible.

The resin of the winding wire flows at the time of the heat curing after the electrifying step, and the thermal cross-linking is made after self-fusing. Conditions of the heat curing after the electrifying step, require 160° C. to 180° C., and 1 hour to 3 hours, but it is preferable that the conditions on the process are the low temperature and the short time as much as possible.

A conductor according to the embodiment, is a linear conductor which is same as a core of the general insulated wire, and is formed of a copper wire, an aluminum wire, an alloy wire thereof, or the like.

As a copper wire, any one of tough pitch copper, oxygen-free copper, and deoxidized copper may be used as a material, and any one of annealed copper wire and hard-drawn copper wire may be used. Moreover, a plated copper wire where tin, nickel, silver, aluminum or the like is plated on a surface, may be used.

As an aluminum wire, any one of hard-drawn aluminum wire and semihard-drawn aluminum wire may be used. Still more, as an alloy wire, copper-tin alloy, copper-silver alloy, copper-zinc alloy, copper-chromium alloy, copper-zirconium alloy, aluminum-copper alloy, aluminum-silver alloy, aluminum-zinc alloy, aluminum-iron alloy, I-aluminum alloy (Aldrey Aluminium) or the like, may be used.

As a shape of the conductor according to the embodiment, any one of a round wire of which a cross section is a circular shape, and a flat wire of which a cross section is a rectangular shape, may be used. Moreover, any one of a single wire which is formed of one conductor, and a stranded wire which is formed by stranding a plurality of conductors, may be used.

It is the feature that the insulating resin layer according to the embodiment, uses the thermoplastic phenoxy resin having a bisphenol A type skeleton and a bisphenol F type skeleton. As a phenoxy resin having the bisphenol A type skeleton and the bisphenol F type skeleton, it is possible to use “YP-70” (Nippon Steel & Sumikin Chemical Co., Ltd.). Furthermore, the phenoxy resin may be an acrylic-modified phenoxy resin, or a vinyl-modified phenoxy resin. Moreover, the acrylic-modified is one type of the vinyl-modified. Still more, at the same time as “YP-70”, it is possible to use “YP-50” having only the bisphenol A type skeleton (Nippon Steel & Sumikin Chemical Co., Ltd.).

The insulating resin layer according to the embodiment, is configured of the thermoplastic resin which is used as a main ingredient (50 weight % or more of a whole of the insulating resin layer in total), and is cross-linked by the heat treatment after the extrusion process. Accordingly, after the extrusion process, and before the heat treatment, it is in the state of not flowing. In the state of not flowing, the insulating resin layer has self-fusing properties. Furthermore, the insulating resin layer is converted into the heat curable resin by the cross-linking, and the heat resistance is improved.

As a thermoplastic resin which is contained in the insulating resin layer according to the embodiment, it is preferable that the phenoxy resin is used. Moreover, as a cross-linking agent for cross-linking the thermoplastic resin, a bismaleimide compound, an epoxy compound, or a block isocyanate may be used. When the epoxy compound is used as a cross-linking agent, it is preferable that imidazole is included as a catalyst.

As an epoxy compound, there is an aromatic epoxy resin, an alicyclic epoxy resin, a novolac epoxy resin, an aliphatic epoxy resin, a glycidyl ester epoxy resin, a glycidyl amine type epoxy resin, a glycidyl acryl type epoxy resin, a bisphenol A type epoxy resin, a bisphenol F type epoxy resin, or a polyester type epoxy resin. Among them, it is preferable that jER1001, jER1002, jER1003, jER1004, jER1006 or jER1007 of the bisphenol A type epoxy resin of which a basic skeleton is similar to the phenoxy resin, and which has an alcoholic hydroxyl group, is used.

As a block isocyanate, duranate series “17B-60P”, “TPA-B80E” (manufactured by Asahi Kasei Chemicals Corporation) or the like, may be used.

As a bismaleimide compound, 4,4′-diphenyl methane bismaleimide “BMI-1000” (manufactured by Daiwa Kasei Industry Co., Ltd.), polyphenyl methane maleimide “BMI-2 000” (manufactured by Daiwa Kasei Industry Co., Ltd.), m-phenylene bismaleimide “BMI-3000” (manufactured by Daiwa Kasei Industry Co., Ltd.), bisphenol A diphenyl ether bismaleimide “BMI-4000” (manufactured by Daiwa Kasei Industry Co., Ltd.), 3,3′-dimethyl-5,5′-diethyl-4,4′-diphenylmethane bismaleimide “BMI-5000” or “BMI-5100” (manufactured by Daiwa Kasei Industry Co., Ltd.), 4-methyl-1,3-phenylene-bismaleimide “BMI-7000” (manufactured by Daiwa Kasei Industry Co., Ltd.) or the like, may be used.

When the insulating resin layer according to the embodiment, includes the epoxy-containing compound, it is possible to use an amine-based catalyst, imidazoles, an aromatic sulfonium salt or the like, as a catalyst. Furthermore, a phenol resin or an acid anhydride may be used as an additive. Here, the additive to be described, is an additive contributing to cross-linking reaction. For example, a phenol aralkyl resin (having a phenylene skeleton, a diphenylene skeleton or the like), a naphthol aralkyl resin and a polyoxystyrene resin may be used in the phenol resin. As a phenol resin, an aniline-modified resol resin, a resol type phenol resin such as a dimethyl ether resol resin, a novolac type phenol resin such as a phenol novolac resin, a cresol novolac resin, a tert-butylphenol novolac resin or a nonylphenol novolac resin, a special phenol resin such as a dicyclopentadiene-modified phenol resin, a terpene-modified phenol resin or a triphenol methane type resin, may be used. As a polyoxystyrene resin, poly(p-oxystyrene) may be used. Among them, it is preferable that H-4 of which phenol novolac-based mp is 100° C. or less, is used. As an acid anhydride, tetrahydrophthalic anhydride, hexahydrophthalic anhydride or the like, may be used.

As an amine-based catalyst, meta-xylene diamine, trimethyl hesa methylene diamine, or the imidazoles may be used. Specifically, 2-phenyl-imidazole, diazabicycloundecene or the like, may be used.

It is preferable that a film thickness of the insulating resin layer according to the embodiment, is 50 μm or more. If the film thickness of the insulating resin layer is 50 μm or more, it is possible to secure pressure resistance of the insulated wire in the high density state of degrees that the insulated wires are close to each other. However, if the film thickness is 200 μm or more, the resin crack is likely to be caused at the time of winding the wire.

On an inside of the insulating resin layer in the insulated wire according to the embodiment, another insulating resin layer may be included.

For example, the insulated wire according to the embodiment, is wound around a stator core which is included in a stator, as a winding wire. The rotary electric machine includes general motor components such as a rotor and an output shaft, in addition to the stator described above.

By including the insulated wire which is excellent in the heat resistance and the pressure resistance, the rotary electric machine is suitable as a drive power generating apparatus or a power generator, for example, in a household electric appliance, an industrial electric machinery, a vessel, a railroad, or an electric vehicle, and particularly, in the small-sized or high output rotary electric machine, and the rotary electric machine has the properties that dielectric breakdown by heat, partial discharge, a surge voltage or the like, is unlikely to occur.

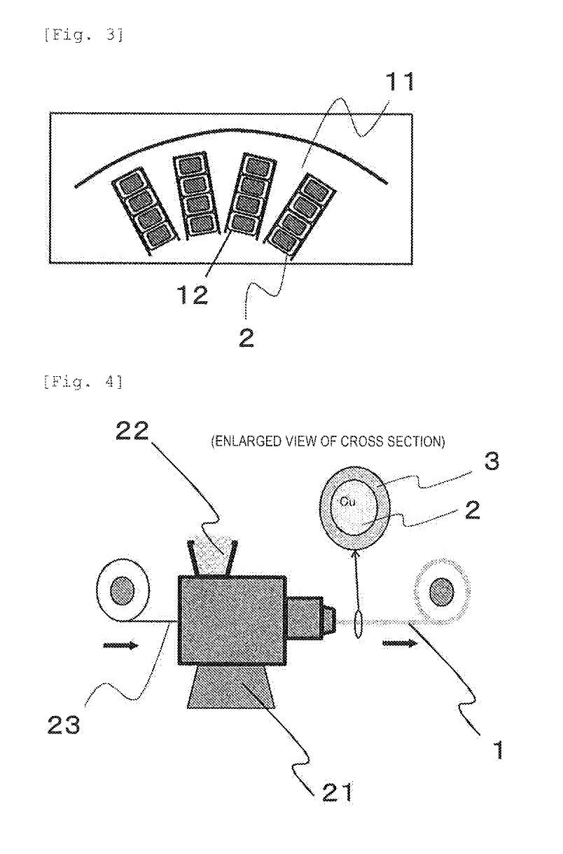

FIG. 3 is an enlarged view of the rotary electric machine (stator) including the insulated wire. In an inner portion of a core material (electromagnetic steel sheet) 11, a conductor 2 and a resin coating film 12 are included. In the embodiment, an insulated wire 1 is configured of the conductor 2, and the resin coating film 12.

### Method for Manufacturing Insulated Wire

Next, by using FIG. 4, a method for manufacturing an insulated wire according to the embodiment, will be described.

The extrusion molding which uses the thermoplastic resin of the insulated wire 1 according to the embodiment, is performed by using an extrusion molding machine 21 such as a crosshead die having a mouth piece according to a desired wire shape.

An insulating resin material 22 for forming a resin layer, is put into a hopper of the extrusion molding machine 21, and is supplied to a cylinder, and is heated up to the temperature of a glass transition temperature or more, and is in the molten state. Thereafter, the insulating resin material 22 which is melted by being heated, is supplied to the crosshead while being kneaded with a screw which is included in the cylinder. Furthermore, the insulating resin material 22 is a resin mixture containing at least a thermoplastic phenoxy resin, an epoxy resin, a cross-linking agent, an inorganic filler and fine rubber particles. At this time, when a total value of the phenoxy resin, the epoxy resin and the cross-linking agent has 100 parts by weight, the inorganic filler has 15 parts by weight to 30 parts by weight, and the fine rubber particles have 3 parts by weight to 10 parts by weight, and thereby, it is possible to manufacture the insulated wire which is good in the balance of the respective properties of the elongation percentage, the melting viscosity and the heat resistance.

A linear conductor core wire 23 passes through the crosshead. An outer periphery of the conductor core wire 23, is coated with the melted insulating resin material 22 at the time of passing through the crosshead, and the insulated wire 1 is formed. Depending on an amount of the insulating resin material 22 to coat the outer periphery, it is possible to control the film thickness of the insulating resin layer of the insulated wire 1. As described above, in order to secure the pressure resistance, it is preferable that the film thickness is 50 μm or more.

Since the insulating resin material 22 with which the insulated wire 1 is coated, is in the state before the thermoplastic resin is cross-linked, the insulating resin material 22 has the self-fusing properties. Accordingly, in the present invention, at the time of manufacturing the stator, the rotor or the like of the rotary electric machine by using the insulated wire 1, without using a varnish, it is possible to adhere by using the self-fusing properties which are included in the insulated wire 1. Consequently, since it is possible to omit an impregnation step to the varnish which is needed at the time of manufacturing the stator in the related art, the present invention has the effect of improving productivity in manufacturing the stator or the like for the rotary electric machine.

When the thermoplastic phenoxy resin which is used in the insulating resin material 22, is in the molten state, the temperature (first heating temperature) is in a range of 100° C. to 150° C., and when the thermoplastic phenoxy resin which is included in the resin mixture, is heat-cured (cross-linked), the temperature (second heating temperature) is in the range of 160° C. to 180° C., and it is preferable that the first heating temperature is lower than the second heating temperature. Moreover, it is preferable that the first heating temperature is lower than the second heating temperature, by 10° C. or more.

It is preferable that the melting viscosity of the heat curable resin, is 1000 Pa·s to 9000 Pa·s, at a shear rate of 60 sec⁻¹, in the temperature range of 100° C. to 150° C. at the time of the extrusion molding. If the melting viscosity is 1000 Pa·s or less, since the dripping of the resin is likely to occur at the time of winding the wire, it is difficult to make the resin thickness of the winding wire uniform. Additionally, if the melting viscosity is 9000 Pa·s or more, on an extrusion molding process, a gap can be likely to occur between the conductor and the resin, and the formation of the uniform film thickness is difficult.

Regarding the self-fusing properties which are one of the features of the heat curable resin, on the manufacturing process of the motor, the winding wire is accommodated in a winding slot after the solventless varnish is impregnated, and the slot and the winding wire are integrated by the heat curing, and the long-term reliability of the motor is improved. Accordingly, in this respect as well, when the resin composition of the present invention is used, since the self-fusing properties are secured at the time of the heat curing, the impregnation varnish is not necessary, and thus, it is advantageous on the process.

As a filler, talc (fine talc, average particle diameter 2.5 μm to 8 μm, manufactured by Nippon Talc Co., Ltd.), mica powder (Micro Mica MK Series, average particle diameter 3 μm to 20 μm, manufactured by Co-op Chemical Co., Ltd.), a glass flake (average particle diameter 10 μm to 40000 μm, manufactured by Nippon Sheet Glass Co., Ltd.), hexagonal boron nitride powder (SHOBN® UHP, average particle diameter 0.2 μm to 12 μm, manufactured by Showa Denko K.K.) or the like, may be used. It is preferable that any one of the particles has the average particle diameter of 30 μm or less, and it is more preferable that the particles in the range of the average particle diameter of 2 μm to 20 μm, are used. Any one of the particles to which a silane-based surface treatment is performed, can be used.

As shapes of the particles, it is preferable that the scale-shaped filler where the hydrogen bonds can be largely formed between the hydroxyl groups of the filler and the hydroxyl groups of the resin, is used.

As a fine rubber particle, trade name Paraloid EXL2655 manufactured by Rohm & Haas Co., Ltd. (average particle diameter 200 nm), trade name Staphyloid AC3355 manufactured by Ganz Chemical Co., Ltd. (average particle diameter 100 nm to 500 nm), Zefiac F351 (average particle diameter 300 nm) or the like, may be used. It is preferable that the particle diameter is in the range of the average particle diameter of 50 nm to 800 nm so as to be excellent in crack resistance of the resin with easy kneading, and without increasing the viscosity of the resin.

Moreover, by combining simplex or two types or more of the known coupling agents such as epoxy silane, aminosilane, ureidosilane, vinylsilane, alkylsilane, organic titanate and aluminum alkylate, it is possible to mix the combination with the heat curable resin of the present invention, as necessary. Still more, it is possible to mix by combining alone or two types or more of flame retardants such as red phosphorus, phosphoric acid, phosphoric ester, melamine, a melamine derivative, a compound having a triazine ring, a cyanuric acid derivative, a nitrogen-containing compound such as an isocyanuric acid derivative, a phosphorus nitrogen-containing compound such as cyclophosphazene, a metal compound such as a zinc oxide, an iron oxide, molybdenum oxide, or ferrocene, an antimony oxide such as an antimony trioxide, an antimony tetroxide or an antimony pentoxide, and a brominated epoxy resin.

In other words, the features of the present invention are that the insulating resin layer of the insulated wire has the thermoplastic phenoxy resin, the epoxy resin, the cross-linking agent, the inorganic filler and the fine rubber particles, as illustrated in Table 1, and when the total value of the phenoxy resin, the epoxy resin and the cross-linking agent has 100 parts by weight, the inorganic filler has 15 parts by weight to 30 parts by weight, and the fine rubber particles have 3 parts by weight to 10 parts by weight. It is possible to improve the elongation percentage by using the inorganic filler and the fine rubber particles, but since the elongation percentage is not improved in the case that the inorganic filler and the fine rubber particles have too small or too large parts by weight, it is appropriate for the inorganic filler and the fine rubber particles to be in the range.

Moreover, as illustrated in Table 1, the insulated wire of the present invention, can be configured by any one of (1) the phenoxy resin contains a phenoxy resin having a bisphenol A type skeleton and a bisphenol F type skeleton, and (2) the phenoxy resin contains a first phenoxy resin having a bisphenol A type skeleton and a bisphenol F type skeleton, and a second phenoxy resin having a bisphenol A type skeleton.

Still more, in the insulated wire of the present invention, the elongation percentage may be 5% or more, and less than 100%, and may be preferably 30% or more, and less than 80%. The insulated wire of the present invention, has the feature that the viscosity of the insulating resin layer at the temperature of 100° C. to 150° C., is 1000 Pa·s to 9000 Pa·s.

Additionally, the insulated wire of the present invention, has the feature that when the total value of the phenoxy resin, the epoxy resin and the cross-linking agent has 100 parts by weight, maleimide has 3 parts by weight to 15 parts by weight. By adding the maleimide of the range, the increase of the viscosity can be suppressed, and the heat resistance can be improved.

Moreover, the insulated wire of the present invention, has the feature that the insulating resin layer has the self-fusing properties. Still more, in the insulated wire of the present invention, it is preferable that scale mica of which the average particle diameter is in the range of 2 μm to 20 μm, is used as an inorganic filler. In the insulated wire of the present invention, it is preferable that the average particle diameter of the fine rubber particle is in the range of 50 nm to 800 nm.

### EXAMPLES

Next, the present invention will be specifically described by illustrating Examples, but the technical scope of the present invention is not limited thereto. Hereinafter, the materials which are used in the present invention, are illustrated. The materials are intactly used.

YP-50 (Nippon Steel & Sumikin Chemical Co., Ltd., phenoxy resin)
YP-70 (Nippon Steel & Sumikin Chemical Co., Ltd., phenoxy resin)
EP828 (Mitsubishi Chemical Corporation, epoxy resin)
EP1001 (Mitsubishi Chemical Corporation, epoxy resin)
EP1004 (Mitsubishi Chemical Corporation, epoxy resin)
YDCN-700-7 (Nippon Steel & Sumikin Chemical Co., Ltd., epoxy resin)
H-4 (Meiwa Plastic Industries, Ltd., phenol curing agent)
P200 (Mitsubishi Chemical Corporation, imidazole-based curing accelerator)
2PHZ-PW (Shikoku Chemicals Corporation, imidazole-based curing accelerator)
BMI-2300 (Daiwa Kasei Industry Co., Ltd., phenylmethane maleimide)
SJ005 (Yamaguchi Mica Co., Ltd., scale mica of average particle diameter of 5 μm)
SJ010 (Yamaguchi Mica Co., Ltd., scale mica of average particle diameter of 10 μm)
EXL2655 (manufactured by The Dow Chemical Company, fine rubber particles of primary particle diameter of 0.2 μm)

TABLE 1

| | | | | | | | COMPAR- | COMPAR- | COMPAR- |
|---|---|---|---|---|---|---|---|---|---|
| | | | | | | | ATIVE | ATIVE | ATIVE |
| | EXAM- | EXAM- | EXAM- | EXAM- | EXAM- | EXAM- | EXAM- | EXAM- | EXAM- |
| USED MATERIAL | PLE 1 | PLE 2 | PLE 3 | PLE 4 | PLE 5 | PLE 6 | PLE 1 | PLE 2 | PLE 3 |
| YP-50 (PHENOXY RESIN) | | | 30 | | | 20 | | 80 | |
| YP-70 (PHENOXY RESIN) | 80 | 80 | 50 | 70 | 80 | 60 | 80 | | 100 |
| EP828 (EPOXY RESIN) | | | 10 | 10 | | | | | |
| EP1001 (EPOXY RESIN) | 10 | 10 | | | 5 | 10 | 10 | 10 | |
| EP1004 (EPOXY RESIN) | | | | | 5 | | | | |
| YDCN-700-7 (EPOXY RESIN) | | | | 10 | | | | | |
| H-4 (PHENOL CURING AGENT) | 10 | 10 | 10 | | 10 | 10 | 10 | | |
| NAPHTHOL ZILOCK αNX-2.5 | | | | 10 | | | | 10 | |
| (PHENOL CURING AGENT) | | | | | | | | | |
| P200 (IMIDAZOLE-BASED | 1 | 1 | | 1 | | 1 | 1 | 1 | 1 |
| CURING ACCELERATOR) | | | | | | | | | |
| 2PHZ-PW (IMIDAZOLE-BASED | | | 1.5 | | 1.5 | | | | |
| CURING ACCELERATOR) | | | | | | | | | |
| BMI-2300 (MALEIMIDE) | | | | 10 | | | | | 30 |
| SJ005 (SCALE MICA) | 20 | 20 | | | 10 | 10 | | | |
| SJ010 (SCALE MICA) | | | 30 | 25 | 15 | 15 | | 35 | 20 |
| EXL2655 (FINE RUBBER | 6 | 6 | 6 | 6 | 7 | 6 | | 15 | 5 |
| PARTICLE) | | | | | | | | | |
| ELONGATION PERCENTAGE | 42 | 42 | 50 | 38 | 46 | 78 | 4.5 | 65 | 18 |
| (%) | | | | | | | | | |
| MELTING VISCOSITY | 2500 | 2500 | 8600 | 4000 | 3000 | 6100 | 900 | 12000 | 850 |
| (Pa · s) | | | | | | | | | |
| EXTRUSION TEMPERATURE | 140 | 140 | 145 | 140 | 140 | 140 | 120 | 170 | 120 |
| (° C.) | | | | | | | | | |
| CROSS-LINKING | 180 | 180 | 180 | 180 | 180 | 180 | 180 | 180 | 180 |
| TEMPERATURE (° C.) | | | | | | | | | |
| HEAT RESISTANCE | 200 | 210 | 200 | 200 | 200 | 200 | 165 | 190 | 150 |
| INDEX (° C.) | | | | | | | | | |
| DIELECTRIC BREAKDOWN | 45 | 49 | 40 | 35 | 50 | 38 | UNMEA- | 12 | UNMEA- |
| STRENGTH AFTER | | | | | | | SURABLE | | SUREABLE |
| HEATING OF 260° | | | | | | | | | |
| C./20 DAYS (kV/mm) | | | | | | | | | |
| NOTES | ONE | TWO | ONE | ONE | ONE | ONE | ONE | ONE | ONE |
| | LAY- | LAY- | LAY- | LAY- | LAY- | LAY- | LAY- | LAY- | LAY- |
| | ERED | ERED | ERED | ERED | ERED | ERED | ERED | ERED | ERED |
| | WIRE | WIRE | WIRE | WIRE | WIRE | WIRE | WIRE | WIRE | WIRE |

### Example 1

The composition which is illustrated in Table 1, is put in a polyethylene bag, and is loosely blended, and is put in a double spindle kneading machine (Imoto Machinery Co., Ltd., IMC-197C type, temperature 125° C., number of rotation 20 rpm) of a cleaning agent, and is kneaded. A tablet-shaped heat curable resin is obtained.

Next, the manufacturing of a self-fusing winding wire which uses the heat curable resin as an insulating resin, will be described. An angled wire of 1.5 mm×3.2 mm, is sufficiently washed with acetone or the like, and thereafter, is heated (140° C.) by an oven. On the outer periphery of the angled wire, the insulating resin layer of the heat curable resin in Table 1, is extrudinly formed into one layer at 140° C. by performing the extrusion molding. For a goal of a resin thickness of 0.10 mm, a pulling speed of the angled wire is changed into 5 m/min to 30 m/min, and the extrusion molding is performed. The resin thickness of the winding wire is changed by an extrusion speed of the resin, the speed of the angled wire or the viscosity of the resin. After cooling the winding wire, the winding wire is wound by a pulley.

The elongation percentage of the heat curable resin to which the extrusion molding is performed, is 42%. Here, after the extrusion molding of the obtained winding wire, the winding wire is baked at 180° C. for 1 hour in a constant temperature bath, and an insulated wire having the resin thickness of approximately 0.1 mm according to Example 1, is obtained.

The temperature of pieces of the cured material is constantly increased (5° C./min) by a differential scanning calorimeter to be a room temperature up to 250° C., but the heat along with the cross-linking of the heat curable resin, is not observed, and it is confirmed that the cross-linking is finished at 180° C. for 1 hour.

The self-fusing properties are confirmed as follows. While horizontally overlapping with two winding wires of a length of 1 m which are obtained in Example 1, two winding wires are heated at 180° C. for 1 hour by a warm-air dryer. As a result, a space between the conductors of the cross-linked winding wires, is 0.18 mm, and the winding wires are strongly adhered. Moreover, the conduction between the winding wires is not confirmed.

The elongation percentage of the resin is calculated as follows. The kneaded resin which comes out of a nozzle of the double spindle kneading machine (Imoto Machinery Co., Ltd., IMC-197C type, temperature 135° C., number of rotation 20 rpm), is pulled at the speed of 6 m/min, and a fiber having the diameter of 350 μm to 500 μm, is prepared. The fiber is pulled at the speed of 50 mm/min in 127 mm of a distance between the marked wires by using a tensile tester (Shimadzu Corporation, autograph AGS-100G type, Load cell SBE1kN), and the elongation percentage of the resin is calculated according to the following equation (1) from the broken distance.

Elongation percentage (%)=((distance between the marked wires at the time of being broken off−distance between the marked wires)/distance between the marked wires)×100 (1)

The resin viscosity is measured (nozzle diameter φ1.0 mm, and nozzle length 20 mm) in the range of the room temperature to 250° C. (speed of temperature-up 5° C./min) by putting the pellet-shaped heat curable resin in a high shear viscometer (manufactured by UBM, capillary rheometer Rheosol-CR100). Here, a value of a shear speed: 60 (sec-1) is illustrated in the molding temperature (140° C.). The resin of Example 1 is 2500 (Pa·s).

Here, a heat resistance index means a retention temperature at which it takes 20,000 hours to reduce the weight as 5 weight % by retaining the resin composition at a fixed temperature.

Actually, at the time of calculating the heat resistance index, the following acceleration method is used. First, the amount of time it takes for the weight to be reduced by 5 weight % at the different retention temperatures of two types or more, is measured. Next, by using Arrhenius equation of the following equation (1), a reciprocal of each retention temperature (absolute temperature) is taken on a horizontal axis, and a logarithm of the amount of time it takes for the weight to be reduced by 5 weight %, is plotted on a vertical axis, and thereby, it is possible to derive an activation energy Ea (unit is kcal/mol) of the decomposition reaction of the insulating resin relating to the reduction in the weight. Moreover, in the equation (1), θ is referred to as the reduced time, and becomes a peculiar constant in the used resin composition. The constant θ can be calculated from the plotted intercept. R is a gas constant (value is 1,987 cal/K·mol), and T is the retention temperature (unit is K: absolute temperature).

$$t ( time which is needed in the reduction of 5 weight \% ) = θ \cdot {e}^{[ \frac{- Ea}{RT} ]} \qquad ( 1 )$$

If the activation energy and the reduced time are calculated from the plot, 20,000 hours is substituted with a left side of the equation (1), and the calculated activation energy and the calculated reduced time are substituted with a right side, and thereby, it is possible to calculate the retention temperature T at which it takes 20,000 hours to reduce the weight by 5 weight %, and the retention temperature becomes the heat resistance index.

As a method of a heat analysis, a method (Friedman-Ozawa method) for measuring the temperature in the case of reducing the weight of 5 weight % by scanning at a plurality of temperature-up speeds, is used. In the method, with respect to each temperature-up speed, the temperature in the case of reducing the measured weight by a predetermined amount (for example, 5 mass %), is plotted, and thereby, it is possible to derive the activation energy of the decomposition reaction of the insulating resin relating to the reduction in the weight.

Moreover, there is a method (Ozawa-Flynn-Wall method) for measuring the amount of time it takes for the weight to be reduced by 5 weight % in the different retention temperatures of two types or more. In the method, with respect to each retention temperature, the time it takes for the measured weight to be reduced (for example, 5 mass %) is plotted, and thereby, it is possible to derive the activation energy of the decomposition reaction of the insulating resin relating to the reduction in the weight.

It is possible to calculate the heat resistance index from the value of the activation energy which is derived by any one of the methods.

Furthermore, the calculated heat resistance index is a value which is calculated under the assumption that the heat resistant life of the resin composition is determined only by a structure change, and the structure change proceeds only in one reaction. Therefore, even in the case of the insulating resins of the same types, when one includes the additive such as an antioxidant lowering the activation energy of the decomposition reaction, and the above-mentioned plotting has linearity, the different heat resistance indexes are calculated respectively, and relative merits may occur in the heat resistance of the insulating resins of the same types. In the present invention, even when the insulating resins of the same types are stacked, the case of forming the insulating resin layer according to the relative merits of the heat resistance based on the heat resistance index, is included in the technical scope of the invention. The heat resistance index of the resin of Example 1 is 200° C.

Dielectric breakdown strength is measured in conformity to JIS C2110. By the vacuum press on a SUS electrode (50 mmφ), and by using the pellet-shaped heat curable resin of Example 1, a sample is made as the curable resin having the resin thickness of 0.05 mm to 1.0 mm (heating condition: 180° C./1 h, pressure: 1 MPa). The sample is placed between a globe-shaped electrode (20 mmφ) and the SUS electrode in silicon oil (room temperature), and a breakdown voltage (BDV1) is calculated, by which the sample is broken in 10 seconds to 20 seconds at a fixed pressure-up speed (normally, 1 kV/sec). An initial value and a result after the heating of 260° C./20 days, are illustrated. Acceleration conditions of the heating of 260° C./20 days illustrate 20,000 hours or more by being converted into 200° C. from the Arrhenius experimental rule. The initial value of the dielectric breakdown strength is 101 kV/mm, and the dielectric breakdown strength after the heating of 260° C./20 days, is 45 kV/mm. The values are values that may be sufficiently fit for the actual use.

Hitherto, the properties of the heat curable resin of Example 1 are illustrated that the elongation percentage is 42% before the heat curing, and the melting viscosity is 2500 Pa·s at the extrusion temperature (140° C.), and the cross-linking temperature is 180° C./1 hour, and the heat resistance index after the curing is 200° C., and the initial value of the dielectric breakdown strength is 101 kV/mm, and the dielectric breakdown strength after the heating of 260° C./20 days is 45 kV/mm.

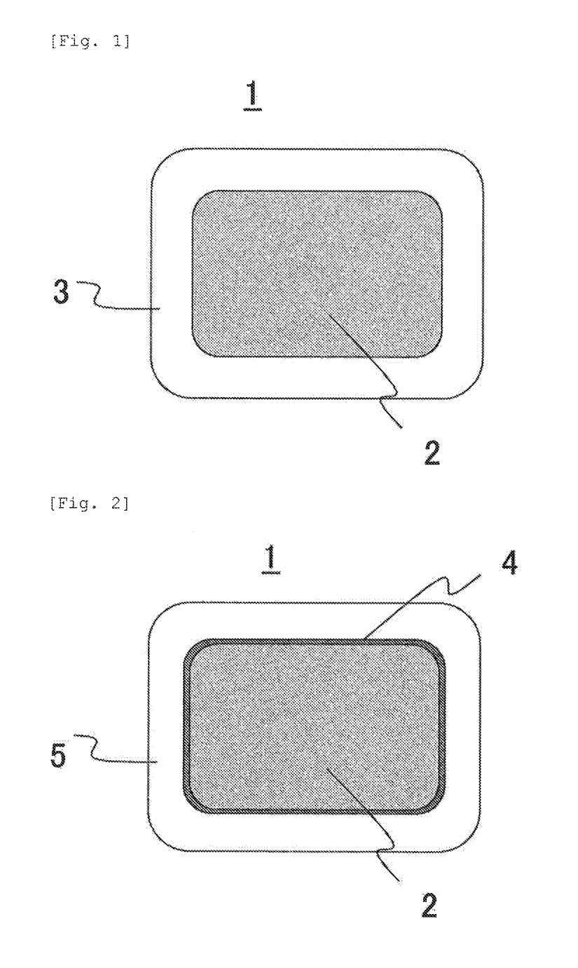

FIG. 1 is a schematic cross-sectional view of the insulated wire according to Example 1. In the insulated wire 1, the conductor 2 is a core wire of which the cross section has the shape of the angled wire, and the insulating resin layer 3 of which the main ingredient is the phenoxy resin, covers the whole circumference of the conductor 2.

Hitherto, even in the case of not using a high-priced super engineering plastic, by heat-treating a low-priced heat curable resin after the extrusion, it is confirmed to have the heat resistance of the common super engineering plastic.

Hereinafter, Examples 2 to 6 will be described.

### Example 2

An insulated wire according to Example which is made by stacking the insulating resin layers of two layers on the conductor, is prepared. As a conductor, an angled wire 2 which is made of copper, is used. Moreover, an inner layer in a resin stacked body, is formed using heat curable polyimide varnish “Sunever SE-150” (manufactured by Nissan Chemical Industries, Ltd.), and an outer insulating resin layer is formed of a resin mixture 3 of Example 1.

On the outer periphery of the angled wire 2, the heat curable polyimide is applied, and is temporarily dried at the room temperature. Therefore, by baking the heat curable polyimide at 300° C. for 1 hour in the constant temperature bath, a polyimide resin layer (inner layer) is formed. The film thickness of the formed resin layer (inner layer) is 10 μm to 15 μm. Subsequently, on the outer periphery of the resin layer (inner layer), the insulated wire where the insulating resin layer which is configured of the resin is formed by the extrusion molding, is prepared in conformity to Example 1. The film thickness of the resin layer (outer layer) is 0.10 mm.

FIG. 2 is a schematic cross-section view of an insulated wire according to Example 2. In the insulated wire 1, the conductor 2 is a core wire of which the cross section has the shape of the angled wire, and an inner insulating resin layer 4 which is the heat curable polyimide, covers the whole circumference of the conductor 2. The outer periphery is used as an outer insulating resin layer 5, and is coated with the heat curable resin which is prepared in Example 1.

Moreover, if being compared with Example 1, by arranging the heat curable polyimide layer as an inner insulating resin layer 4, the improvement of the heat resistance is confirmed.

### Example 3

With the compositions which are written together in Table 1, an insulated wire of Example 3 is obtained in conformity to Example 1. The elongation percentage is 50%, and the melting viscosity is 8600 Pa·s at the extrusion temperature (145° C.), and the cross-linking temperature is 180° C./1 hour, and the heat resistance index is 200° C., and the initial value of the dielectric breakdown strength is 98 kV/mm, and the dielectric breakdown strength after the heating of 260° C./20 days is 40 kV/mm.

### Example 4

With the compositions which are written together in Table 1, an insulated wire of Example 4 is obtained in conformity to Example 1. The elongation percentage is 38%, and the melting viscosity is 4000 Pa·s at the extrusion temperature (140° C.), and the cross-linking temperature is 180° C./i hour, and the heat resistance index is 200° C., and the initial value of the dielectric breakdown strength is 102 kV/mm, and the dielectric breakdown strength after the heating of 260° C./20 days is 35 kV/mm.

### Example 5

With the compositions which are written together in Table 1, an insulated wire of Example 5 is obtained in conformity to Example 1. The elongation percentage is 46%, and the melting viscosity is 3000 Pa·s at the extrusion temperature (140° C.), and the cross-linking temperature is 180° C./1 hour, and the heat resistance index is 200° C., and the initial value of the dielectric breakdown strength is 109 kV/mm, and the dielectric breakdown strength after the heating of 260° C./20 days is 50 kV/mm.

### Example 6

With the compositions which are written together in Table 1, a self-fusing winding wire of Example 6 is obtained in conformity to Example 1. The elongation percentage is 78%, and the melting viscosity is 6100 Pa·s at the extrusion temperature (140° C.), and the cross-linking temperature is 180° C./1 hour, and the heat resistance index is 200° C., and the initial value of the dielectric breakdown strength is 92 kV/mm, and the dielectric breakdown strength after the heating of 260° C./20 days is 38 kV/mm.

Since the heat curable resin composition of the present application has the melting viscosity of the range of 1000 Pa·s to 9000 Pa·s at the extrusion temperature (140° C. to 145° C.) from Examples 1 to 6, the extrusion molding is easy, and the elongation percentage of the resin is 38% to 78%, and the resin crack is not caused at the time of the winding wire work of the insulated wire using the same. Any one of the heat resistance index is confirmed to be 200° C. to 210° C. of the common super engineering plastic. Still more, the dielectric breakdown strength is confirmed to be 35 kV/mm or more even after the heating of 260° C./20 days, and it is found that any one is sufficiently fit for the actual use.

Subsequently, Comparative Examples will be described.

### Comparative Example 1

In Comparative Example 1, by using the compositions which are written together in Table 1, an insulated wire is prepared in conformity to the manufacturing method of Example 1. The resin layer of Comparative Example 1 is formed without the scale filler and the fine rubber particles.

The properties of Comparative Example 1 are that the elongation percentage is 4.5%, and the melting viscosity is 900 Pa·s at the extrusion temperature (120° C.), and the cross-linking temperature is 180° C./1 hour, and the initial value of the dielectric breakdown strength is 95 kV/mm, but the dielectric breakdown strength after the heating of 260° C./20 days may not be measured. The reason is that the resin after the heating of 260° C./20 days is degraded, and the large crack occurs. If being compared with Example 1, in particular, the effect of the scale filler is considered. Still more, although the elongation percentage is 4.5% and small, it is caused by the effects of the scale filler and the fine rubber. Additionally, since the melting viscosity is low, the unevenness of the resin thickness becomes large.

Next, the heat resistance of the resin cured material according to Comparative Example 1, is confirmed. However, the resin is degraded, and it is not possible to calculate the heat resistance index of the heat curable resin according to Comparative Example 1.

Hitherto, from the results of Comparative Example 1, it is considered that the elongation percentage and shape maintainability of the insulated wire of the winding wire, depend on the mica and the fine rubber of the insulating resin layer.

### Comparative Example 2

Since Comparative Example 2 is aimed at the increase of the elongation percentage, an insulated wire is prepared, in conformity to the compositions which are written together in Table 1, and the manufacturing method of Example 1. In order to increase the elongation percentage, YP-50 of high molecular weight is used in the phenoxy resin, and a mixing amount of the scale mica and the fine rubber is increased. As written together in Table 1, the results are that the elongation percentage is 65%, and the melting viscosity is 12000 Pa·s at the extrusion molding temperature of 170° C., and the heat resistance index is 175° C. In the dielectric breakdown strength, the initial value is 95 kV/mm, and on the other hand, the value after the heating of 260° C./20 days is 12 kV/mm.

According to Comparative Example 2, the winding wire where the elongation percentage is large, and the crack is unlikely to be caused, is obtained, but the winding wire temperature and the melting viscosity are high, and thus, the insulating winding wire having the uniform film thickness, is not obtained. The elongation percentage and the melting viscosity are not compatible.

As described in Comparative Example 2, in the case of using only “YP-50” having only the bisphenol A type skeleton as a phenoxy resin, there is a problem that the extrusion temperature or the melting viscosity of the insulated wire becomes large, in comparison with the case of using “YP-70” having the bisphenol A type skeleton and the bisphenol F type skeleton.

Moreover, in Comparative Example 2, when the total value of the phenoxy resin, the epoxy resin and the cross-linking agent has 100 parts by weight, the inorganic filler has 35 parts by weight, and the fine rubber particles have 15 parts by weight, and it deviates from the preferable range of the present invention that the inorganic filler has 15 parts by weight to 30 parts by weight, and the fine rubber particles have 3 parts by weight to 10 parts by weight. Therefore, it is considered that the melting viscosity becomes very large.

### Comparative Example 3

In Comparative Example 3, by using the compositions which are written together in Table 1, an insulated wire is prepared in conformity to the manufacturing method of Example 1. The compositions are compositions without the epoxy resin and the phenol curing agent. As written together in Table 1, the results are illustrated that the elongation percentage is 18%, and the melting viscosity is 850 Pa·s at the extrusion molding temperature of 120° C., and the heat resistance index is 150° C. In the dielectric breakdown strength, the initial value is 109 kV/mm, and on the other hand, the value after the heating of 260° C./20 days is unmeasurable. The reason is that the resin is partially peeled. Moreover, the melting viscosity is low, and in the extrusion molding, the self-fusing winding wire having the uniform film thickness, is not obtained.

Hitherto, from the results of Comparative Example 1 to Comparative Example 3, it is confirmed that the elongation percentage, the melting viscosity, the heat resistance and the shape maintainability of the winding wire, depend on the mixing of the phenoxy resin, the curing agent, the scale mica and the fine rubber of the heat curable resin. That is, the conclusion is that Examples have the effects which are derived from that the extrusion molding is easy, and the elongation percentage of the resin after winding the wire, is large, and the winding wire is self-fused by the heat treatment.

### REFERENCE SIGNS LIST

1 INSULATED WIRE
2 CONDUCTOR
3 INSULATING RESIN LAYER
4 INNER INSULATING RESIN LAYER
5 OUTER INSULATING RESIN LAYER
11 CORE MATERIAL
12 RESIN COATING FILM
21 EXTRUSION MOLDING MACHINE
22 INSULATING RESIN MATERIAL
23 CONDUCTOR CORE WIRE

1. An insulated wire comprising:
an insulating resin layer that is formed on an outer periphery of a conductor,
wherein the insulating resin layer has a thermoplastic phenoxy resin, an epoxy resin, a cross-linking agent, an inorganic filler, and fine rubber particles, and
when a total value of the phenoxy resin, the epoxy resin and the cross-linking agent has 100 parts by weight, the inorganic filler has 15 parts by weight to 30 parts by weight, and the fine rubber particles have 3 parts by weight to 10 parts by weight.

2. The insulated wire according to claim 1,
wherein the phenoxy resin contains a phenoxy resin having a bisphenol A type skeleton and a bisphenol F type skeleton.

3. The insulated wire according to claim 1,
wherein the phenoxy resin contains a first phenoxy resin having a bisphenol A type skeleton and a bisphenol F type skeleton, and a second phenoxy resin having a bisphenol A type skeleton.

4. The insulated wire according to claim 1,
wherein an elongation percentage is 5% or more, and less than 100%.

5. The insulated wire according to claim 1,
wherein an elongation percentage is 30% or more, and less than 80%.

6. The insulated wire according to claim 1,
wherein viscosity of the insulating resin layer at a temperature of 100° C. to 150° C., is 1000 Pa·s to 9000 Pa·s.

7. The insulated wire according to claim 1,
wherein when a total value of the phenoxy resin, the epoxy resin and the cross-linking agent has 100 parts by weight, maleimide has 3 parts by weight to 15 parts by weight.

8. The insulated wire according to claim 1,
wherein the insulating resin layer has self-fusing properties.

9. The insulated wire according to claim 1,
wherein the inorganic filler is scale mica, and an average particle diameter is in a range of 2 μm to 20 μm.

10. The insulated wire according to claim 1,
wherein an average particle diameter of the fine rubber particle is in a range of 50 nm to 800 nm.

11. The insulated wire according to claim 1,
wherein a film thickness of the insulating resin layer is 50 μm or more.

12. The insulated wire according to claim 1,
wherein a heat curing temperature of the insulating resin layer is 160° C. to 180° C.

13. The insulated wire according to claim 1,
wherein the insulating resin layer is formed by an extrusion process.

14. A rotary electric machine comprising:
an insulated wire where an insulating resin layer is formed on an outer periphery of a conductor,
wherein the insulating resin layer has a thermoplastic phenoxy resin, an epoxy resin, a cross-linking agent, an inorganic filler, and fine rubber particles, and
when a total value of the phenoxy resin, the epoxy resin and the cross-linking agent has 100 parts by weight, the inorganic filler has 15 parts by weight to 30 parts by weight, and the fine rubber particles have 3 parts by weight to 10 parts by weight.

15. A method for manufacturing an insulated wire, comprising:
a heating step of heating a resin mixture including a thermoplastic phenoxy resin, an epoxy resin, a cross-linking agent, an inorganic filler, and fine rubber particles to be in a molten state; and
a conductor coating step of coating the resin mixture which is in the molten state, to a conductor by extrusion molding,
when a total value of the phenoxy resin, the epoxy resin and the cross-linking agent has 100 parts by weight, the inorganic filler has 15 parts by weight to 30 parts by weight, and the fine rubber particles have 3 parts by weight to 10 parts by weight.

16. The method for manufacturing an insulated wire according to claim 15,
wherein the phenoxy resin occupies 50 weight % or more of a whole of the resin mixture.

17. The method for manufacturing an insulated wire according to claim 15,
wherein a heating temperature of the heating step is 100° C. to 150° C., and a heat curing temperature of the resin mixture is 160° C. to 180° C.

18. The method for manufacturing an insulated wire according to claim 15,
wherein the heating temperature of the heating step is lower than a heat curing temperature of the resin mixture, by 10° C. or more.

19. The method for manufacturing an insulated wire according to claim 15,
wherein the resin mixture with which the conductor is coated, is heated at a temperature which is higher than the heating temperature of the heating step, and the phenoxy resin is cross-linked by the cross-linking agent.
